(19) United States
(12) Patent Application Publication
(10) Pub. No.: US 2024/0154102 A1
(43) Pub. Date: May 9, 2024

(54) NEGATIVE ELECTRODE ACTIVE MATERIAL AND BATTERY

(71) Applicants: Panasonic Holdings Corporation, Osaka (JP); TOYOTA JIDOSHA KABUSHIKI KAISHA, Aichi (JP)

(72) Inventors: Hiroki YABE, Osaka (JP); Masaki HIRASE, Hyogo (JP); Takamasa OHTOMO, Okazaki-shi (JP)

(21) Appl. No.: 18/414,331

(22) Filed: Jan. 16, 2024

Related U.S. Application Data
(63) Continuation of application No. PCT/JP2022/021996, filed on May 30, 2022.

(30) Foreign Application Priority Data
Jul. 20, 2021 (JP) 2021-119659

(51) Int. Cl. H01M 4/36; H01M 4/02; H01M 4/38; H01M 4/583

(52) U.S. Cl. CPC H01M 4/366; H01M 4/385; H01M 4/583; H01M 2004/021; H01M 2004/027

(57) ABSTRACT

A negative electrode active material according to one aspect of the present disclosure includes: a porous silicon particle; and a carbon material, wherein the porous silicon particle has a plurality of pores, the carbon material covers at least a part of an inner surface of each of the pores, and a ratio of a specific surface area of the negative electrode active material to a specific surface area of the porous silicon particle is 40% or more and 99% or less.

This application is a continuation of PCT/JP2022/021996 filed on May 30, 2022, which claims foreign priority of Japanese Patent Application No. 2021-119659 filed on Jul. 20, 2021, the entire contents of both of which are incorporated herein by reference.

### BACKGROUND OF THE INVENTION

### 1. Field of the Invention

The present disclosure relates to a negative electrode active material and a battery.

### 2. Description of Related Art

JP 2012-084522 A discloses a negative electrode for lithium-ion secondary batteries, wherein at least one surface of a current collector includes a porous silicon particle having a three-dimensional network structure.

### SUMMARY OF THE INVENTION

Conventional techniques are required to improve charge-discharge cycle characteristics of a battery that uses silicon as an active material.

A negative electrode active material according to one aspect of the present disclosure includes:
a porous silicon particle; and
a carbon material, wherein
the porous silicon particle has a plurality of pores,
the carbon material covers at least a part of an inner surface of each of the pores, and
a ratio of a specific surface area of the negative electrode active material to a specific surface area of the porous silicon particle is 40% or more and 99% or less.

The present disclosure can improve charge-discharge cycle characteristics of a battery that uses silicon as an active material.

### BRIEF DESCRIPTION OF THE DRAWINGS

FIG. 1A is a cross-sectional view schematically showing a configuration of a negative electrode active material of Embodiment 1.

FIG. 1B is a cross-sectional view schematically showing a configuration of a porous silicon particle of Embodiment 1.

FIG. 2 is a cross-sectional view schematically showing a configuration of a battery of Embodiment 2.

### DETAILED DESCRIPTION

(Findings on which the Present Disclosure is Based)

In all-solid-state lithium-ion batteries, both electrons and lithium ions are required to be efficiently supplied to an active material in an electrode. In all-solid-state lithium-ion batteries, active materials are dispersed in an electrode. A common negative electrode desirably has both an electron conduction path formed of an active material and a conductive additive that are in contact with each other and an ion conduction path formed of solid electrolytes joined to each other.

Silicon particles are sometimes used as a negative electrode active material. Silicon particles can occlude lithium ions by being alloyed with lithium. Silicon particles can better enhance the capacity of a battery than other active materials such as graphite.

A silicon particle expands at the time of charging when occluding lithium and shrinks at the time of discharging when releasing lithium. Accordingly, the repeated volume changes of the silicon particle through the charge-discharge cycle adversely affect the state of contact between the silicon particle and a conductive additive and that between the silicon particle and a solid electrolyte. That is, an interface between the silicon particle and the conductive additive and that between the silicon particle and the solid electrolyte are lessened. This deteriorates the performance of a battery.

In order to avoid such a problem, there have been made various proposals aiming at reducing the volume changes due to the expansion and shrinkage of the silicon particle at the time of charging and discharging.

In JP 2012-084522 A, a porous silicon particle having a three-dimensional network structure is used as a negative electrode active material so as to ensure a void in the three-dimensional network structure as a space for expansion at the time of charging.

From the viewpoint of electron transport, it is important that a negative electrode active material and a conductive additive should be in a favorable state of contact with each other in a negative electrode. However, the porous silicon particle disclosed in JP 2012-084522 A has a rugged shape on a surface thereof. Therefore, the porous silicon particle is unlikely to be in a favorable contact with a conductive additive.

The present inventors have made intensive studies on techniques for improving the charge-discharge cycle characteristics of a battery. As a result, they have arrived at the technique of the present disclosure.

### (Summary of One Aspect According to the Present Disclosure)

A negative electrode active material according to a first aspect of the present disclosure includes:
a porous silicon particle; and
a carbon material, wherein
the porous silicon particle has a plurality of pores,
the carbon material covers at least a part of an inner surface of each of the pores, and
a ratio of a specific surface area of the negative electrode active material to a specific surface area of the porous silicon particle is 40% or more and 99% or less.

The carbon material has electron conductivity. In the above configuration, the carbon material covers at least a part of the inner surface of each of the pores of the porous silicon particle, and therefore a lot of electron conduction paths are formed between the porous silicon particle and the carbon material. This makes it possible to transport electrons even into the pores of the porous silicon particle, enhancing the electronic conductivity of the negative electrode active material. Moreover, since the carbon material is present inside the porous silicon particle, the carbon material is inhibited from dropping from the porous silicon particle. Thereby, the charge-discharge cycle characteristics of a battery are improved.

Also, in the above configuration, the ratio of the specific surface area of the negative electrode active material to the specific surface area of the porous silicon particle is 40% or more and 99% or less, and thus the expansion and shrinkage of the porous silicon particle that occur in charge and discharge reactions are less likely to be hindered by the carbon material. Therefore, a space for expansion at the time of charging can be ensured sufficiently in the negative electrode active material.

According to a second aspect of the present disclosure, for example, in the negative electrode active material according to the first aspect, the ratio of the specific surface area of the negative electrode active material to the specific surface area of the porous silicon particle may be 50% or more and 75% or less. The above configuration makes it possible to sufficiently provide electron conduction paths even inside the porous silicon particle while ensuring the space for expansion at the time of charging in the negative electrode active material. Moreover, since the specific surface area of the negative electrode active material is sufficiently smaller than that of the porous silicon particle, the negative electrode active material is more likely to be in a favorable contact with another solid electrolyte in the negative electrode than when only the porous silicon particle is used as the negative electrode active material. As a result, the charge-discharge cycle characteristics of a battery can be further improved.

According to a third aspect of the present disclosure, for example, in the negative electrode active material according to the first or second aspect, a ratio of a volume of the carbon material to a volume of the porous silicon particle may be 0.01% or more and less than 2%. The above configuration makes it possible to enhance the electronic conductivity while reducing a decrease in ionic conductivity of the negative electrode active material.

A battery according to a fourth aspect of the present disclosure includes:
a negative electrode;
a positive electrode; and
an electrolyte layer disposed between the negative electrode and the positive electrode, wherein
the negative electrode includes the negative electrode active material according to any one of the first to third aspects.

The above configuration can make it possible to improve the charge-discharge cycle characteristics of a battery.

A negative electrode active material according to a fifth aspect of the present disclosure includes:
a porous silicon particle; and
a carbon material, wherein
the porous silicon particle has a plurality of pores, and
the carbon material covers at least a part of an inner surface of each of the pores.

Hereinafter, an embodiment of the present disclosure will be described with reference to the drawings.

### Embodiment 1

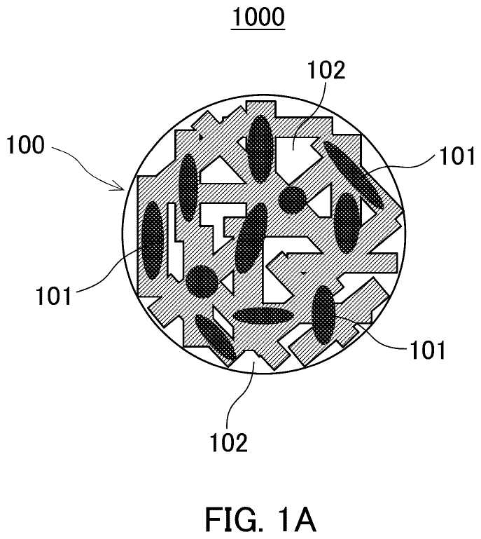

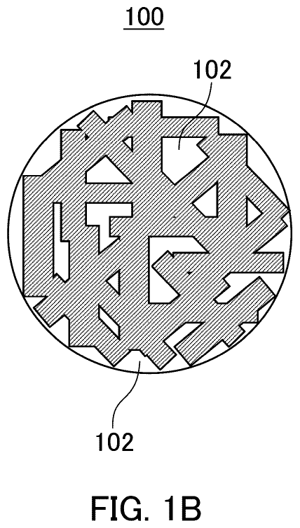

FIG. 1A is a cross-sectional view schematically showing a configuration of a negative electrode active material 1000 of Embodiment 1. FIG. 1B is a cross-sectional view schematically showing a configuration of a porous silicon particle 100 of Embodiment 1.

The negative electrode active material 1000 includes a porous silicon particle 100 and a carbon material 101. The porous silicon particle 100 has a plurality of pores 102. The carbon material 101 covers at least a part of an inner surface of each of the pores 102.

The porous silicon particle 100 can function as an active material. The carbon material 101 has electron conductivity. Since the carbon material 101 covers at least a part of the inner surface of each of the pores 102 of the porous silicon particle 100, a lot of electron conduction paths are formed between the porous silicon particle 100 and the carbon material 101. This makes it possible to transport electrons even into the pores 102 of the porous silicon particle 100, enhancing the electronic conductivity of the negative electrode active material 1000. Moreover, since the carbon material 101 is present inside the porous silicon particle 100, the carbon material 101 is inhibited from dropping from the porous silicon particle 100. Thereby, the charge-discharge cycle characteristics of a battery are improved.

In the present disclosure, the term “at least a part” means a part or all of the corresponding region.

In the present description, ratios may be expressed in percentage.

A ratio of a specific surface area of the negative electrode active material 1000 to a specific surface area of the porous silicon particle 100 is 40% or more and 99% or less. In the above configuration, the expansion and shrinkage of the porous silicon particle 100 that occur in charge and discharge reactions are less likely to be hindered by the carbon material 101. Therefore, a space for expansion at the time of charging is ensured sufficiently in the negative electrode active material 1000.

Another material, such as a conductive additive, may be present inside each of the pores 102. When a space is ensured because the carbon material 101 does not fill the whole of each of the pores 102, the space functions as the “space for expansion at the time of charging.”

The carbon material 101 may reach a central part of the porous silicon particle 100. For example, when a cross-section of the negative electrode active material 1000 selected arbitrarily from a powder of the negative electrode active material 1000 is observed using a scanning electron microscope (SEM) or a transmission electron microscope (TEM), the carbon material 101 may be present at a central part of the cross-section. The term “central part of a cross-section” is defined as, for example, a region within a distance of r/3 from the center of a circle having a minimum area that surrounds a cross-section of a particle of the negative electrode active material 1000. The symbol “r” is a radius of the circle. For the cross-section observation, the negative electrode active material 1000 that is relatively large and has a shape close to a spherical shape can be selected.

The ratio of the specific surface area of the negative electrode active material 1000 to the specific surface area of the porous silicon particle 100 may be 50% or more and 75% or less. The above configuration makes it possible to sufficiently provide electron conduction paths even inside the porous silicon particle 100 while ensuring the space for expansion at the time of charging in the negative electrode active material 1000. Moreover, since the specific surface area of the negative electrode active material 1000 is sufficiently smaller than that of the porous silicon particle 100, the negative electrode active material 1000 is more likely to be brought into contact with another solid electrolyte in the negative electrode than when only the porous silicon particle 100 is used as the negative electrode active material. As a result, the charge-discharge cycle characteristics of a battery can be further improved.

The specific surface area of each of the porous silicon particle 100 and the negative electrode active material 1000 can be determined, for example, by converting, by a BET (Brunauer-Emmett-Teller) method, adsorption isotherm data obtained by the later-described gas adsorption method using a nitrogen gas.

The specific surface area of the porous silicon particle 100 is not particularly limited. The specific surface area of the porous silicon particle 100 is 10 m²/g or more, for example. When the specific surface area is 10 m²/g or more, the inner surface of each of the pores 102 can be coated with a sufficient amount of the carbon material 101. The larger specific surface area the porous silicon particle 100 has, the larger area of the inner surface of each of the pores 102 the carbon material 101 can coat. The upper limit of the specific surface area of the porous silicon particle 100 is not particularly limited. The upper limit of the specific surface area of the porous silicon particle 100 may be 500 m²/g.

The specific surface area of the negative electrode active material 1000 is not particularly limited. The specific surface area of the negative electrode active material 1000 is 8 m²/g or more, for example. The upper limit of the specific surface area of the negative electrode active material 1000 is not particularly limited. The upper limit of the specific surface area of the negative electrode active material 1000 may be 400 m²/g.

The carbon material 101 may cover or does not need to cover uniformly the inner surface of each of the pores 102 of the porous silicon particle 100. That is, the inner surface of each of the pores 102 of the porous silicon particle 100 may have a portion where the carbon material 101 is absent. When the carbon material 101 does not cover uniformly the inner surface of each of the pores 102, a decrease in ionic conductivity of the negative electrode active material 1000 is reduced. That is, it is possible to inhibit lithium ion conduction caused by contact between the porous silicon particle 100 and a solid electrolyte from being hindered in the negative electrode.

The carbon material 101 may have a shape of a thin film that covers at least a part of the inner surface of each of the pores 102. In an in-plane direction of the carbon material 101 having the shape of a thin film, electronic conduction tends to be promoted. The fact that the carbon material 101 has the shape of a thin film can be confirmed by observing a cross-section of the negative electrode active material 1000 using a scanning electron microscope (SEM) or a transmission electron microscope (TEM).

In the present disclosure, the term “shape of a thin film” means a state in which the carbon material 101 is formed thinly.

The thin film of the carbon material 101 may have an average thickness of less than 30 nm. The above configuration makes it possible to maintain appropriately the total amount of the carbon material with respect to the entire negative electrode. This makes it possible to reduce a decrease in weight energy density of the negative electrode.

The average thickness of the thin film of the carbon material 101 may be 10 nm or less. The above configuration makes it possible to sufficiently provide electron conduction paths even inside the porous silicon particle 100 while ensuring the space for expansion at the time of charging in the negative electrode active material 1000. As a result, the charge-discharge cycle characteristics of a battery can be further improved. The lower limit of the average thickness of the thin film of the carbon material 101 is not particularly limited. The lower limit of the average thickness of the thin film of the carbon material 101 may be 3 nm.

The average thickness of the thin film of the carbon material 101 can be determined in the following manner, for example. Specifically, the negative electrode active material 1000 is first processed to expose a cross-section of the negative electrode active material 1000. The negative electrode active material 1000 can be processed, for example, using a Cross Section Polisher (registered trademark). A smooth cross-section of the negative electrode active material 1000 can be formed using a Cross Section Polisher. Then, the cross-section of the negative electrode active material 1000 is observed using a scanning electron microscope (SEM) or a transmission electron microscope (TEM). An SEM image or TEM image of the cross-section of the negative electrode active material 1000 can be obtained thereby. Next, the porous silicon particle 100, the carbon material 101, and the pores 102 are recognized in the SEM image or TEM image. These may be recognized on the basis of contrast of the image or on the basis of the results of element analysis such as energy dispersive X-ray spectroscopy (EDS). Next, the thickness of the thin film of the carbon material 101 is measured at arbitrarily selected ten points in the SEM image or TEM image. These measurement values are averaged to determine the average thickness of the thin film of the carbon material 101.

The carbon material 101 has its own shape that is not particularly limited. For example, the thin film of the carbon material 101 may be composed of an accumulation of fine particles, in a shape of a plate, a needle, a sphere, an ellipsoid, or the like, of the carbon material 101.

When the thin film of the carbon material 101 is formed of an accumulation of fine particles of the carbon material 101, the fine particles of the carbon material 101 may have a median size of 1 nm or more and 20 nm or less, or a median size of 1 nm or more and 5 nm or less.

The term “median size” commonly means a particle size at 50% in a volume-based cumulative particle size distribution. The volume-based particle size distribution is measured, for example, using a laser diffraction measurement apparatus.

The thin film of the carbon material 101 may cover or does not need to cover uniformly the inner surface of each of the pores 102 of the porous silicon particle 100.

The carbon material 101 may cover, not only in the shape of a thin film but also in a shape other than the shape of a thin film, at least a part of the inner surface of each of the pores 102 of the porous silicon particle 100. The shape other than the shape of a thin film is a layer shape or a porous shape, for example. The thin film or the layer of the carbon material 101 may have a porous structure.

The carbon material 101 may cover not only the inner surface of each of the pores 102 of the porous silicon particle 100 but also at least a part of an outer surface of the porous silicon particle 100. The above configuration allows even more electron conduction paths to be formed between the porous silicon particle 100 and the carbon material 101. This can further enhance the electronic conductivity of the negative electrode active material 1000.

The carbon material 101 may cover or does not need to cover uniformly the outer surface of the porous silicon particle 100. That is, the outer surface of the porous silicon particle 100 may have a portion where the carbon material 101 is absent. When the carbon material 101 does not cover uniformly the outer surface of the porous silicon particle 100, a decrease in ionic conductivity of the negative electrode active material 1000 is reduced. That is, it is possible to inhibit lithium ion conduction caused by contact between the porous silicon particle 100 and a solid electrolyte from being hindered by the carbon material 101 in the negative electrode.

The carbon material 101 may have a shape of a thin film that covers at least a part of the outer surface of the porous silicon particle 100.

The thin film of the carbon material 101 may cover or does not need to cover uniformly the outer surface of the porous silicon particle 100.

The carbon material 101 may cover, not only in the shape of a thin film but also in a shape other than the shape of a thin film, at least a part of the outer surface of the porous silicon particle 100.

The porous silicon particle 100 may include silicon as a main component, and, for example, may substantially consist of silicon. In the present disclosure, the term “main component” means a component whose content is highest in the porous silicon particle 100 on a mass basis. The phrase “substantially consist of silicon” means other components that alter essential characteristics of the material are excluded. However, the porous silicon particle 100 may include impurities other than silicon.

In the porous silicon particle 100, the plurality of pores 102 may be arranged three-dimensionally and continuously. At least one of the plurality of pores 102 may penetrate the porous silicon particle 100. As described above, the porous silicon particle 100 may have a so-called three-dimensional network structure.

The porous silicon particle 100 may be a secondary particle including a plurality of primary particles aggregated. The above configuration makes it possible to produce easily the porous silicon particle 100 having the plurality of pores 102 inside thereof by using silicon fine particles.

When the porous silicon particle 100 is the secondary particle, the plurality of primary particles may be in contact with each other.

The primary particles each have a shape that is not particularly limited. The shape of each of the primary particles may be, for example, a shape of a plate, a flake, a needle, a sphere, an ellipsoid, or the like.

For example, the pores 102 each may be arranged between two of the primary particles. The plurality of pores 102 may be arranged three-dimensionally and continuously. At least one of the plurality of pores 102 may penetrate the porous silicon particle 100. As described above, when the porous silicon particle 100 is the secondary particle, the porous silicon particle 100 can have a three-dimensional network structure.

The primary particles each may include silicon as a main component, and, for example, may substantially consist of silicon. However, the primary particles each may include impurities other than silicon.

Some of the pores 102 may be filled partially with the carbon material 101.

The pores 102 of the porous silicon particle 100 have a shortest diameter that is 1 nm or more and 200 nm or less, for example. When the shortest diameter is 1 nm or more, the carbon material 101 can be introduced into the pores 102 easily. When the shortest diameter is 200 nm or less, it is possible for the pores 102 to allow the porous silicon particle 100 to have a sufficient space for expansion.

The shortest diameter of the pores 102 can be determined in the following manner, for example. First, an SEM image or TEM image of a cross-section of the negative electrode active material 1000 is obtained in the same manner as mentioned above. Next, the porous silicon particle 100, the carbon material 101, and the pores 102 are recognized in the SEM image or TEM image. Then, the center of gravity of one of the pores 102 is determined in the SEM image or TEM image. The shortest diameter of diameters of the pore 102 can be considered the shortest diameter of the pores 102, the diameters passing through the center of gravity of the pore 102. In the SEM image or TEM image of the cross-section of the negative electrode active material 1000, a diameter of a circle having a minimum area that surrounds the pore 102 may be considered the shortest diameter of the pore 102.

The lower limit of the shortest diameter of the pores 102 may be 10 nm. The upper limit of the shortest diameter of the pores 102 may be 100 nm.

The pores 102 may have an average shortest diameter of 1 nm or more and 200 nm or less. The average shortest diameter of the pores 102 can be determined by determining the shortest diameters of an arbitrary number (e.g., 5) of the pores 102 in the SEM image or TEM image of the cross-section of the negative electrode active material 1000, and then averaging these values.

When the SEM image or TEM image shows a plurality of the pores 102, the shortest diameter that is the greatest of the respective shortest diameters of the plurality of pores 102 shown may be 1 nm or more and 200 nm or less.

The fact that the carbon material 101 covers at least a part of the inner surface of each of the pores 102 can be confirmed by the SEM observation or TEM observation of the cross-section of the negative electrode active material 1000 mentioned above. In addition, use of a gas adsorption method using nitrogen or a mercury intrusion method makes it possible to confirm that the carbon material 101 is present inside the pores 102 on the basis of a pore diameter of the porous silicon particle 100 and a pore diameter of the negative electrode active material 1000.

The gas adsorption method using a nitrogen gas makes it possible to obtain a pore distribution in which the volume of the pores is specified for each diameter D by converting, by a BJH (Barrett-Joyner-Halenda) method, adsorption isotherm data obtained from a specimen having the pores. The pore distribution is, for example, a graph showing a relation between the pore diameter D and a log differential pore volume.

In the mercury intrusion method, pressurized mercury is first injected into a specimen having pores. A pore distribution can be determined from a relation between the pressure applied to the mercury and the amount of the mercury injected into the specimen. Specifically, for the specimen, a diameter D of a pore into which the mercury was injected can be determined by the following relational expression (I). In the relational expression (I), the symbol γ represents a surface tension of the mercury. The symbol θ represents a contact angle between the mercury and a wall surface of the specimen. The symbol P represents a pressure applied to the mercury.

D=−4γ cos θ÷P (I)

The pressure P is changed in stages, and the amount of the injected mercury is measured for each stage. The amount of the injected mercury can be considered a cumulative value of the volumes of the pores having a diameter up to the diameter D, the diameter D corresponding to a particular pressure P. A pore distribution in which the volume of the pores is specified for each diameter D can be obtained thereby. The pore distribution is, for example, a graph showing a relation between the pore diameter D and a log differential pore volume.

In the present embodiment, pore distributions can be obtained, for example, respectively for the negative electrode active material 1000 in which the carbon material 101 is present inside the pores 102 and the porous silicon particle 100 in which the carbon material 101 is absent inside the pores 102 by the BJH method that is a gas adsorption measurement using nitrogen or the mercury intrusion method. As the porous silicon particle 100 in which the carbon material 101 is absent inside the pores 102, the porous silicon particle 100 in which the carbon material 101 has not been introduced into the pores 102 can be used. The porous silicon particle 100 obtained by removing the carbon material 101 from the negative electrode active material 1000 may also be used. The carbon material 101 can be removed from the negative electrode active material 1000 using a solvent, etc., for example.

On the basis of the pore distribution of the negative electrode active material 1000 and that of the porous silicon particle 100, it is possible to confirm that the carbon material 101 is present inside the pores 102 in the negative electrode active material 1000. Specifically, for example, the log differential pore volume at a particular diameter D is determined for the pore distribution of each of the negative electrode active material 1000 and the porous silicon particle 100. When the log differential pore volume of the negative electrode active material 1000 is smaller at the particular diameter D than the log differential pore volume of the porous silicon particle 100, it can be understood that the carbon material 101 is present inside the pores 102 of the porous silicon particle 100. Additionally, when the diameter D at a peak in the pore distribution of the negative electrode active material 1000 is smaller than the diameter D at a peak in the pore distribution of the porous silicon particle 100, it can be understood that the carbon material 101 is present inside the pores 102 of the porous silicon particle 100.

When the porous silicon particle 100 has the plurality of pores 102, an average pore diameter S, determined by the BJH method that is a gas adsorption measurement using nitrogen or the mercury intrusion method, of the porous silicon particle 100 is not particularly limited. The average pore diameter S, determined by the BJH method that is a gas adsorption measurement using nitrogen or the mercury intrusion method, of the porous silicon particle 100 is, for example, 1 nm or more and 200 nm or less. The lower limit of the average pore diameter S may be 10 nm. The upper limit of the average pore diameter S may be 100 nm.

The average pore diameter S of the porous silicon particle 100 can be determined in the following manner, for example. First, a pore distribution showing a relation between the pore diameter D and the log differential pore volume is obtained for the porous silicon particle 100 in which the carbon material 101 is absent inside the pores 102 by the BJH method that is a gas adsorption measurement using nitrogen or the mercury intrusion method mentioned above. Next, a peak in the pore distribution of the porous silicon particle 100 is determined. The diameter D at the peak in the pore distribution can be considered the average pore diameter S. The diameter D at the peak in the pore distribution corresponds to a mode diameter of the pores.

The porous silicon particle 100 has a shape that is not particularly limited. The shape of the porous silicon particle 100 is, for example, a shape of a sphere or an ellipsoid. The shape of the porous silicon particle 100 may be a shape of a needle, a plate, or the like. When the porous silicon particle 100 is the secondary particle, the porous silicon particle 100 may have, on a surface thereof, a rugged shape caused by the primary particles in the shape of a plate or the like.

The porous silicon particle 100 has a median size that is, for example, but not particularly limited to, 50 nm or more and 30 μm or less. The porous silicon particle 100 having a median size of 50 nm or more can be easily handled and is thus suitable for producing the negative electrode active material 1000. The carbon material 101 can be easily introduced into the pores 102 of the porous silicon particle 100 having a median size of 30 μm or less. The porous silicon particle 100 may have a median size of 200 nm or more and 10 μm or less.

The porous silicon particle 100 has a porosity that is not particularly limited. The porosity of the porous silicon particle 100 may be 5% or more, for example. When the porosity is 5% or more, the inner surface of each of the pores 102 can be coated with a sufficient amount of the carbon material 101. The upper limit of the porosity of the porous silicon particle 100 is not particularly limited. The upper limit of the porosity of the porous silicon particle 100 is 50%, for example. When the porosity is 50% or less, the porous silicon particle 100 tends to have a sufficiently high strength.

In the present disclosure, the term “porosity of the porous silicon particle 100” means a ratio of the total volume of the plurality of pores 102 to the volume of the porous silicon particle 100 including the plurality of pores 102.

The porosity of the porous silicon particle 100 can be measured, for example, by the mercury intrusion method. The porosity of the porous silicon particle 100 can also be calculated from the pore volume obtained by the BJH method that is a gas adsorption measurement using nitrogen.

A ratio of a volume of the carbon material 101 to a volume of the porous silicon particle 100 may be 0.01% or more and less than 2%. The above configuration makes it possible to enhance the electronic conductivity while reducing a decrease in ionic conductivity of the negative electrode active material 1000.

The ratio of the volume of the carbon material 101 to the volume of the porous silicon particle 100 may be 0.1% or more and 1.5% or less.

The ratio of the volume of the carbon material 101 to the volume of the porous silicon particle 100 can be determined using a carbon sulfur analyzer, for example. Specifically, the total amount of carbon elements (C) included in the negative electrode active material 1000 is first measured using a carbon sulfur analyzer. Considering the amount of carbon elements (C) measured is entirely derived from the carbon material 101, the amount is converted into the carbon material 101. Thereby, a mass of the carbon material 101 included in the negative electrode active material 1000 can be determined. The volume of the carbon material 101 can be calculated from the mass of the carbon material 101 and a true density of the carbon material 101. The volume of the porous silicon particle 100 can be calculated from a mass of the porous silicon particle 100 and a true density of the porous silicon particle 100. The volume of the porous silicon particle 100 may be determined by subtracting the volume of the carbon material 101 from a volume of the negative electrode active material 1000. The volume of the negative electrode active material 1000 can be calculated from a mass of the negative electrode active material 1000 and a true density of the negative electrode active material 1000. The true density of the porous silicon particle 100, the true density of the carbon material 101, and the true density of the negative electrode active material 1000 can be measured by a pyknometer method, for example. In this manner, the ratio of the volume of the carbon material 101 to the volume of the porous silicon particle 100 can be determined.

When the negative electrode active material 1000 is included in an electrode, the negative electrode active material 1000 can be taken out in the following manner, for example. An electrode including the negative electrode active material 1000 is dispersed in a solvent that does not dissolve the carbon material 101. The obtained dispersion medium is subjected to a centrifuge method so that only the negative electrode active material 1000 can be taken out because of difference in particle density.

Examples of the carbon material 101 include graphite having a six membered ring network of a carbon atom, and amorphous carbon.

### <Method for Producing Negative Electrode Active Material>

Next, a method for producing the above-mentioned negative electrode active material 1000 will be described. The negative electrode active material 1000 can be produced in the following manner, for example.

The porous silicon particle 100 having the plurality of pores 102 is prepared. The porous silicon particle 100 may be a secondary particle formed from a plurality of primary particles aggregated.

The method for coating, with the carbon material 101, at least a part of the inner surface of each of the pores 102 of the porous silicon particle 100 is not particularly limited. For example, it is possible to coat, with the carbon material 101, at least a part of the inner surface of each of the pores 102 of the porous silicon particle 100 by using a vapor phase deposition method such as a CVD method. The CVD method is a method in which, for example, hydrocarbon, such as ethylene, acetylene, or naphthalene, is brought into contact with a silicon particle while being heated and allowed to make a reaction so that a carbon material, such as graphite or amorphous carbon, is applied to the silicon particle. In the CVD method, while a kiln filled with the porous silicon particle 100 is being rotated, a gas to be a carbon source is introduced thereinto and the porous silicon particle 100 is heated. This makes it possible for the carbon material 101 to be applied to the inner surface of each of the pores 102 of the porous silicon particle 100.

The method for producing the porous silicon particle 100 having the plurality of pores 102 is not particularly limited. The porous silicon particle 100 can be produced, for example, by removing, through elution or the like, a metal other than silicon from a precursor composed of an alloy of silicon and a metal such as lithium, and then washing and drying the silicon.

### Embodiment 2

Hereinafter, Embodiment 2 will be described. The description overlapping that in Embodiment 1 will be omitted as appropriate.

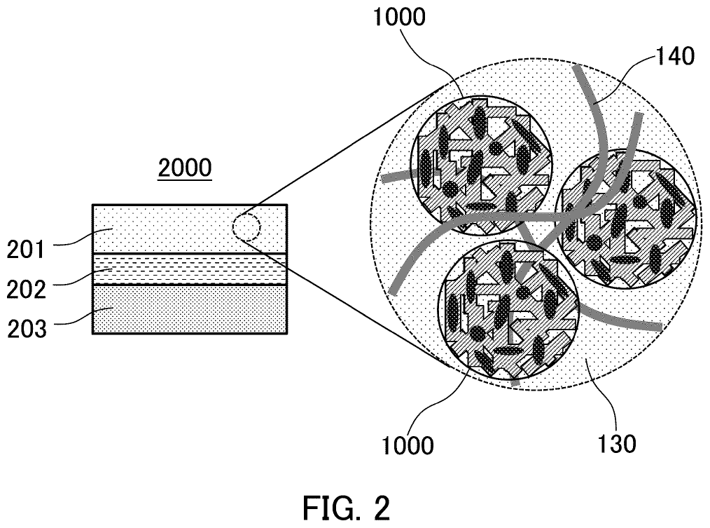

FIG. 2 is a cross-sectional view schematically showing a configuration of a battery 2000 of Embodiment 2.

The battery 2000 includes a negative electrode 201, a positive electrode 203, and an electrolyte layer 202 disposed between the negative electrode 201 and the positive electrode 203. The negative electrode 201 includes the negative electrode active material 1000 of Embodiment 1.

The above configuration makes it possible to improve the charge-discharge cycle characteristics of the battery 2000 because the negative electrode 201 includes the negative electrode active material 1000.

The negative electrode 201 includes, for example, a negative electrode active material layer including the negative electrode active material 1000, and a negative electrode current collector. The negative electrode active material layer is disposed between the negative electrode current collector and the electrolyte layer 202.

In producing the battery 2000, a negative electrode material including the negative electrode active material 1000 is compression-molded to produce the negative electrode active material layer in some cases. The porous silicon particle 100 included in the negative electrode active material 1000 has high hardness. Thus, the negative electrode active material 1000 is likely to maintain the pores 102 even after the compression molding. In other words, in the battery 2000 using the negative electrode active material 1000, the particle shape of the negative electrode active material 1000 is maintained in the negative electrode 201.

It is possible to understand the structure of the negative electrode active material 1000 in the negative electrode 201 by determining a shortest diameter of the pores 102 of the negative electrode active material 1000 included in the negative electrode 201. The shortest diameter of the pores 102 of the negative electrode active material 1000 included in the negative electrode 201 can be determined in the following manner, for example. First, the negative electrode 201 is processed to expose a cross-section of the negative electrode 201. Next, an SEM image or TEM image of the cross-section of the negative electrode 201 is obtained. Next, in the SEM image or TEM image, the negative electrode active material 1000 is recognized, and in addition the porous silicon particle 100, the carbon material 101, and the pores 102 are recognized. Then, the center of gravity of one of the pores 102 is determined in the SEM image or TEM image. The shortest diameter of diameters of the pore 102 can be considered the shortest diameter of the pores 102, the diameters passing through the center of gravity of the pore 102. In the SEM image or TEM image of the cross-section of the negative electrode 201, a diameter of a circle having a minimum area that surrounds the pore 102 may be considered the shortest diameter of the pore 102.

An average shortest diameter of the pores 102 of the negative electrode active material 1000 included in the negative electrode 201 can be determined by determining the shortest diameters of an arbitrary number (e.g., 5) of the pores 102 in the SEM image or TEM image of the cross-section of the negative electrode 201, and then averaging these values.

The negative electrode 201 may further include a solid electrolyte. The solid electrolyte that may be included in the negative electrode 201 is referred to as a first solid electrolyte 130. The first solid electrolyte 130 fills, for example, a space between a plurality of the negative electrode active materials 1000 in the negative electrode 201. The first solid electrolyte 130 may have a shape of a particle. An ion conduction path may be formed by compressing and bonding a lot of particles of the first solid electrolyte 130.

The first solid electrolyte 130 has lithium ion conductivity. The first solid electrolyte 130 includes, for example, at least one selected from the group consisting of an inorganic solid electrolyte and an organic solid electrolyte. The first solid electrolyte 130 may include at least one selected from the group consisting of a sulfide solid electrolyte, an oxide solid electrolyte, a halide solid electrolyte, a polymer solid electrolyte, and a complex hydride solid electrolyte. As the sulfide solid electrolyte, the oxide solid electrolyte, the polymer solid electrolyte, and the complex hydride solid electrolyte, those described below can be used. Specific examples of the halide solid electrolyte will be described later in the description of the electrolyte layer 202.

The first solid electrolyte 130 may include a sulfide solid electrolyte. Since the sulfide solid electrolyte has high reduction stability, the sulfide solid electrolyte is suitable for being combined with the porous silicon particle 100 being a low-electric potential negative electrode material.

The first solid electrolyte 130 may include lithium, phosphorus, sulfur, and halogen. The above configuration makes it possible to enhance the ionic conductivity of the first solid electrolyte 130.

The first solid electrolyte 130 may be represented by the following composition formula (1), for example.

Li_{α}PS_{β}X_{γ} Formula (1)

In the formula (1), α, β, and γ satisfy 5.5≤α≤6.5, 4.55≤β≤5.5, and 0.5≤γ≤1.5. The symbol X includes at least one selected from the group consisting of F, Cl, Br, and I. The symbol X may include at least one selected from the group consisting of Cl and Br. The symbol X may include Cl. The first solid electrolyte 130 may be Li₆PS₅X.

The solid electrolyte represented by the composition formula (1) has, for example, an argyrodite crystal structure. That is, the first solid electrolyte 130 may have an argyrodite crystal structure. Such a first solid electrolyte 130 tends to have high ion conductivity.

Examples of the sulfide solid electrolyte other than the solid electrolyte represented by the composition formula (1) include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂. LiX, Li₂O, MO_{q}, LiₚMO_{q}, or the like may be added thereto. Here, the element X in “LiX” is at least one selected from the group consisting of F, Cl, Br, and I. The element M in “MO_{q}” and “LiₚMO_{q}” is at least one selected from the group consisting of P, Si, Ge, B, Al, Ga, In, Fe, and Zn. The symbols p and q in “MO_{q}” and “LiₚMO_{q}” are each an independent natural number.

The first solid electrolyte 130 may include at least one selected from the group consisting of an oxide solid electrolyte, a polymer solid electrolyte, and a complex hydride solid electrolyte.

As the oxide solid electrolyte can be used, for example, a NASICON solid electrolyte typified by LiTi₂(PO₄)₃ and element-substituted substances thereof; a (LaLi)TiO₃-based perovskite solid electrolyte; a LISICON solid electrolyte typified by LiI₄ZnGe₄O₁₆, Li₄SiO₄, and LiGeO₄ and element-substituted substances thereof; a garnet solid electrolyte typified by Li₇La₃Zr₂O₁₂ and element-substituted substances thereof; Li₃N and H-substituted substances thereof; Li₃PO₄ and N-substituted substances thereof; or a glass or glass ceramic including a base material that includes a Li—B—O compound such as LiBO₂ or Li₃BO₃ and to which a material such as Li₂SO₄, Li₂CO₃, or the like has been added.

For example, a compound of a polymer compound and a lithium salt can be used as the polymer solid electrolyte. The polymer compound may have an ethylene oxide structure. The polymer compound having an ethylene oxide structure can contain a large amount of a lithium salt, and therefore, the ionic conductivity can be further increased. LiPF₆, LiBF₄, LiSbF₆, LiAsF₆, LiSO₃CF₃, LiN(SO₂CF₃)₂, LiN(S₀₂C₂F₅)₂, LiN(SO₂CF₃)(SO₂C₄F₉), LiC(SO₂CF₃)₃, or the like can be used as the lithium salt. As the lithium salt, one lithium salt selected from these may be used alone, or a mixture of two or more lithium salts selected from these may be used.

For example, LiBH₄—LiI or LiBH₄—P₂S₅ can be used as the complex hydride solid electrolyte.

The first solid electrolyte 130 is desirably made of a soft material to achieve a favorable dispersion state with the negative electrode active material 1000. From this perspective, at least one selected from the group consisting of the sulfide solid electrolyte and the halide solid electrolyte is suitable as the first solid electrolyte 130.

The first solid electrolyte 130 has a shape that is not particularly limited. The shape of the first solid electrolyte 130 may be a shape of a needle, a sphere, an ellipsoid, a flake, or the like. The first solid electrolyte 130 may have a shape of a particle.

When the first solid electrolyte 130 has the shape of a particle (e.g., a sphere), the first solid electrolyte 130 may have a median size of 0.3 μm or more and 100 μm or less. When the first solid electrolyte 130 has a median size of 0.3 μm or more, a contact interface between the particles of the first solid electrolyte 130 is not increased too much and an increase in the ionic resistance inside the negative electrode 201 can be reduced. This allows the battery 2000 to operate at a high power.

When the first solid electrolyte 130 has a median size of 100 μm or less, the negative electrode active material 1000 and the first solid electrolyte 130 are likely to be in a favorable dispersion state in the negative electrode 201. This makes it easy to increase the capacity of the battery 2000.

The median size of the first solid electrolyte 130 may be smaller than that of the negative electrode active material 1000. In this case, the negative electrode active material 1000 and the first solid electrolyte 130 can be in a favorable dispersion state in the negative electrode 201.

The negative electrode 201 may further include an additional active material other than the negative electrode active material 1000. The additional active material has a shape that is not particularly limited. The shape of the additional active material may be a shape of a needle, a sphere, an ellipsoid, or the like. The additional active material may have a shape of a particle.

The additional active material may have a median size of 0.1 μm or more and 100 μm or less.

When the additional active material has a median size of 0.1 μm or more, the additional active material and the first solid electrolyte 130 are likely to be in a favorable dispersion state in the negative electrode 201. This improves the charge characteristics of the battery 2000.

When the additional active material has a median size of 100 μm or less, the diffusion rate of lithium in the active material is sufficiently ensured. This allows the battery 2000 to operate at a high power.

The median size of the additional active material may be larger than that of the first solid electrolyte 130. In this case, the additional active material and the first solid electrolyte 130 can be in a favorable dispersion state.

The additional active material includes a material having properties of occluding and releasing metal ions (e.g., lithium ions). A metal material, a carbon material, an oxide, a nitride, a tin compound, a silicon compound, or the like can be used as the additional active material. The metal material may be an elemental metal or an alloy. Examples of the metal material include lithium metal and a lithium alloy. Examples of the carbon material include natural graphite, coke, semi-graphitized carbon, carbon fibers, spherical carbon, artificial graphite, and amorphous carbon. In terms of the capacity density, silicon (Si), tin (Sn), a silicon compound, or a tin compound can be suitably used. The additional active material may include a single active material or a plurality of active materials having different compositions.

The negative electrode active material 1000 and the first solid electrolyte 130 may be in contact with each other as shown in FIG. 2. The negative electrode 201 may include a plurality of the negative electrode active materials 1000 and a plurality of the first solid electrolytes 130.

In the negative electrode 201, the amount of the first solid electrolyte 130 may be equal to or different from the amount of the negative electrode active material 1000.

When the total amount of the negative electrode 201 is 100 mass %, the amount of the negative electrode active material 1000 may be 40 mass % or more and 90 mass % or less, or 40 mass % or more and 80 mass % or less. The negative electrode active material 1000 and the first solid electrolyte 130 are likely to be in a favorable dispersion state in the negative electrode 201 by appropriately adjusting the amount of the negative electrode active material 1000.

For a mass ratio “w1:100−w1” between the active material and the first solid electrolyte 130 in the negative electrode 201, 40≤w1≤90 may be satisfied, or 40≤w1≤80 may be satisfied. When 40≤w1 is satisfied, the battery 2000 has a sufficient energy density. When w1≤90 is satisfied, the battery 2000 can operate at a high power. The term “active material” means that not only the negative electrode active material 1000 but also an additional active material other than the negative electrode active material 1000 is included.

The negative electrode 201 may have a thickness of 10 μm or more and 500 μm or less. When the negative electrode 201 has a thickness of 10 μm or more, the battery 2000 has a sufficient energy density. When the negative electrode 201 has a thickness of 500 μm or less, the battery 2000 can operate at a high power.

The electrolyte layer 202 is a layer including an electrolyte. The electrolyte is a solid electrolyte, for example. That is, the electrolyte layer 202 may be a solid electrolyte layer.

The solid electrolyte that can be included in the electrolyte layer 202 is referred to as a second solid electrolyte. The second solid electrolyte may include at least one selected from the group consisting of a sulfide solid electrolyte, an oxide solid electrolyte, a halide solid electrolyte, a polymer solid electrolyte, and a complex hydride solid electrolyte. As the sulfide solid electrolyte, the oxide solid electrolyte, the polymer solid electrolyte, and the complex hydride solid electrolyte, those described for the first solid electrolyte 130 can be used.

The second solid electrolyte may include a sulfide solid electrolyte.

The second solid electrolyte may include at least one selected from the group consisting of an oxide solid electrolyte, a polymer solid electrolyte, and a complex hydride solid electrolyte.

The second solid electrolyte may include a halide solid electrolyte.

The halide solid electrolyte is represented, for example, by the following composition formula (2).

Li_{α}M_{β}X_{γ} Formula (2)

In the composition formula (2), α, β, and γ are each independently a value greater than 0. The symbol M includes at least one selected from the group consisting of metalloid elements and metal elements other than Li. The symbol X is at least one selected from the group consisting of F, Cl, Br, and I.

In the present disclosure, the term “metalloid elements” refers to B, Si, Ge, As, Sb, and Te. The term “metal elements” refers to all the elements included in Groups 1 to 12 of the periodic table, except for hydrogen, and all the elements included in Groups 13 to 16 of the periodic table, except for B, Si, Ge, As, Sb, Te, C, N, P, O, S, and Se. That is, the terms “metalloid elements” and “metal elements” each refer to a group of elements that can become cations when forming an inorganic compound with a halogen element.

Specifically, Li₃YX₆, Li₂MgX₄, Li₂FeX₄, Li(Al,Ga,In)X₄, Li₃(Al,Ga,In)X₆, or the like can be used as the halide solid electrolyte. In the present disclosure, when an element in a formula is expressed, for example, as “(Al, Ga, In)”, the expression “(Al, Ga, In)” represents at least one selected from the group of elements in the parentheses. That is, the expression “(Al, Ga, In)” is synonymous with the expression “at least one selected from the group consisting of Al, Ga, and In”. The same applies to other elements.

The halide solid electrolyte exhibits high ion conductivity. Therefore, the above configuration can enhance the power density of the battery 2000. The above configuration can also enhance the thermal stability of the battery 2000 and reduce generation of a harmful gas such as hydrogen sulfide.

In the composition formula (2), M may include Y (=yttrium). That is, the halide solid electrolyte included in the electrolyte layer 202 may include Y as a metal element. The above configuration can further enhance the ionic conductivity of the halide solid electrolyte.

The halide solid electrolyte including Y may be a compound represented by the following composition formula (3).

LiₐMe_{b}Y_{c}X1₆ Formula (3)

In the composition formula (3), a+mb+3c=6 and c>0 are satisfied. The symbol Me includes at least one selected from the group consisting of metalloid elements and metal elements other than Li and Y The symbol m is the valence of the element Me. The symbol X1 includes at least one selected from the group consisting of F, Cl, Br, and I. The above configuration can further enhance the ionic conductivity of the halide solid electrolyte. This can further enhance the power density of the battery 2000.

The symbol Me may include, for example, at least one selected from the group consisting of Mg, Ca, Sr, Ba, Zn, Sc, Al, Ga, Bi, Zr, Hf, Ti, Sn, Ta, and Nb. The above configuration can further enhance the ionic conductivity of the halide solid electrolyte. This can further enhance the power density of the battery 2000.

As the halide solid electrolyte including Y can be used, specifically, Li₃YF₆, Li₃YCl₆, Li₃YBr₆, Li₃YI₆, Li₃YBrCl₅, Li₃YBr₃Cl₃, Li₃YBr₅Cl, Li₃YBr₅I, Li₃YBr₃₁₃, Li₃YBrI₅, Li₃YClI₅, Li₃YCl₃I₃, Li₃YCl₅I, Li₃YBr₂Cl₂I₂, Li₃YBrCl₄I, Li₂₇Y_{1.1}Cl₆, Li_{2.5}Y_{0.5}Zr_{0.5}Cl₆, Li_{2.5}Y_{0.3}Zr_{0.7}Cl₆, or the like. The above configuration can further enhance the power density of the battery 2000.

The electrolyte layer 202 may include only one solid electrolyte selected from the group consisting of the above solid electrolytes, or may include two or more solid electrolytes selected from the group consisting of the above solid electrolytes. The plurality of solid electrolytes has different compositions. For example, the electrolyte layer 202 may include the halide solid electrolyte and the sulfide solid electrolyte.

The electrolyte layer 202 may have a thickness of 1 μm or more and 300 μm or less. When the electrolyte layer 202 has a thickness of 1 μm or more, a short-circuit between the negative electrode 201 and the positive electrode 203 is less likely to happen. When the electrolyte layer 202 has a thickness of 300 μm or less, the battery 2000 can operate at a high power.

The positive electrode 203 contributes to operation of the battery 2000 as a counter electrode of the negative electrode 201.

The positive electrode 203 may include a material having properties of occluding and releasing metal ions (e.g., lithium ions). The positive electrode 203 includes, for example, a positive electrode active material. As the positive electrode active material, for example, a metal composite oxide, a transition metal fluoride, a polyanion material, a fluorinated polyanion material, a transition metal sulfide, a transition metal oxysulfide, or a transition metal oxynitride can be used. In particular, when a lithium-containing transition metal oxide is used as the positive electrode active material, it is possible to reduce the manufacturing cost and increase the average discharge voltage.

The positive electrode 203 includes, for example, a positive electrode active material layer including the positive electrode active material, and a positive electrode current collector. The positive electrode active material layer is disposed between the positive electrode current collector and the electrolyte layer 202.

The metal composite oxide selected as the positive electrode active material may include Li and at least one selected from the group consisting of Mn, Co, Ni, and Al. The above configuration can further enhance the energy density of the battery 2000. Examples of such a material include Li(Ni,Co,Al)O₂, Li(Ni,Co,Mn)O₂, and LiCoO₂. For example, the positive electrode active material may be Li(Ni,Co,Mn)O₂.

The positive electrode 203 may include an electrolyte, and may include, for example, a solid electrolyte. The above configuration can enhance the lithium ion conductivity inside the positive electrode 203 and allows the battery 2000 to operate at a high power. The materials described as examples of the second solid electrolyte in the electrolyte layer 202 may be used as the solid electrolyte included in the positive electrode 203.

The positive electrode active material has a shape that is not particularly limited. The shape of the positive electrode active material may be a shape of a needle, a sphere, an ellipsoid, or the like. The positive electrode active material may have a shape of a particle.

The positive electrode active material may have a median size of 0.1 μm or more and 100 μm or less. When the positive electrode active material has a median size of 0.1 μm or more, the positive electrode active material and the solid electrolyte can be in a favorable dispersion state in the positive electrode 203. This enhances the charging capacity of the battery 2000. When the positive electrode active material has a median size of 100 μm or less, the diffusion rate of lithium in the positive electrode active material is sufficiently ensured. This allows the battery 2000 to operate at a high power.

The median size of the positive electrode active material may be larger than that of the solid electrolyte included in the positive electrode 203. In this case, the positive electrode active material and the solid electrolyte can be in a favorable dispersion state in the positive electrode 203.

For a mass ratio “w2:100−w2” between the positive electrode active material and the solid electrolyte included in the positive electrode 203, 40≤w2≤90 may be satisfied. When 40≤w2 is satisfied, the battery 2000 has a sufficient energy density. When w2≤90 is satisfied, the battery 2000 can operate at a high power.

The positive electrode 203 may have a thickness of 10 μm or more and 500 μm or less. When the positive electrode 203 has a thickness of 10 μm or more, the battery 2000 has a sufficient energy density. When the positive electrode 203 has a thickness of 500 μm or less, the battery 2000 can operate at a high power.

The positive electrode active material may be coated with a coating material in order to have a reduced interface resistance against the solid electrolyte. As the coating material, a material with low electron conductivity can be used. As the coating material, the above-mentioned sulfide solid electrolyte, oxide solid electrolyte, halide solid electrolyte, polymer solid electrolyte, or complex hydride solid electrolyte can be used, for example.

The coating material may be an oxide solid electrolyte.

As the oxide solid electrolyte that can be used as the coating material, there can be mentioned a Li—Nb—O compound such as LiNbO₃, a Li—B—O compound such as LiBO₂ and Li₃BO₃, a Li-AI-O compound such as LiAlO₂, a Li—Si—O compound such as Li₄SiO₄, a Li—Ti—O compound such as Li₂SO₄ and Li₄Ti₅O₁₂, a Li—Zr—O compound such as Li₂ZrO₃, a Li—Mo—O compound such as Li₂MoO₃, a Li-V-O compound such as LiV₂O₅, and a Li—W—O compound such as Li₂WO₄. The oxide solid electrolyte has high ionic conductivity. The oxide solid electrolyte has excellent high potential stability. Therefore, use of the oxide solid electrolyte as the coating material can further enhance the charge-discharge efficiency of the battery 2000.

At least one selected from the group consisting of the negative electrode 201, the electrolyte layer 202, and the positive electrode 203 may include a binder to enhance the adhesion between the particles. The binder is used, for example, to enhance the binding properties of the material of an electrode. Examples of the binder include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethylcellulose. As the binder can be used a copolymer of two or more materials selected from tetrafluoroethylene, hexafluoroethylene, hexafluoropropylene, perfluoroalkyl vinylether, vinylidene fluoride, chlorotrifluoroethylene, ethylene, propylene, pentafluoropropylene, fluoromethyl vinyl ether, acrylic acid, and hexadiene. A mixture of two or more materials selected from these may also be used as the binder.

At least one of the negative electrode 201 and the positive electrode 203 may include a conductive additive 140 to enhance the electronic conductivity. As the conductive additive 140 can be used, for example: graphite such as natural graphite and artificial graphite; carbon black such as acetylene black and ketjen black; conductive fibers such as a carbon fiber and a metal fiber; fluorinated carbon; metal powders such as an aluminum powder; conductive whiskers such as a zinc oxide whisker and a potassium titanate whisker; conductive metal oxides such as titanium oxide; and conductive polymer compounds such as polyaniline, polypyrrole, and polythiophene. Using the conductive additive 140 that is carbon-based can seek cost reduction.

In the example shown in FIG. 2, the conductive additive 140 is included in the negative electrode 201. However, the conductive additive 140 is not an essential element.

Examples of a shape of the battery 2000 include coin-type, cylindrical-type, prismatic-type, sheet-type, button-type, flat-type, and layer-built-type.

### <Method for Producing Battery>

The battery 2000 using the negative electrode active material 1000 can be produced in the following manner (a dry method), for example.

A powder of the solid electrolyte is put in a ceramic mold. The powder of the solid electrolyte is pressed to form the electrolyte layer 202. A powder of the negative electrode material is put therein to be on one side of the electrolyte layer 202. The powder of the negative electrode material is pressed to form a negative electrode active material layer on the electrolyte layer 202. The negative electrode material includes the negative electrode active material 1000 and the first solid electrolyte 130. A powder of the positive electrode material is put therein to be on the other side of the electrolyte layer 202. The powder of the positive electrode material is pressed to form a positive electrode active material layer. Thereby, a power generation element including the negative electrode active material layer, the electrolyte layer 202, and the positive electrode active material layer can be obtained.

Current collectors are disposed on each of the top and bottom of the power generation element, and a current collector lead is fixed to each of the current collectors. Thereby, the battery 2000 can be obtained.

The battery 2000 using the negative electrode active material 1000 can be also produced by a wet method. For example, in the wet method, a negative electrode slurry including the negative electrode active material 1000 and the first solid electrolyte 130 is applied onto a current collector to form a coating film. Next, the coating film is made go through rolls or a flat plate press heated to a temperature of 120° C. or higher and is pressed. Thereby, a negative electrode active material layer can be obtained. The electrolyte layer 202 and a positive electrode active material layer are produced in the same manner. Next, the negative electrode active material layer, the electrolyte layer 202, and the positive electrode active material layer are stacked in this order. Thereby, a power generation element can be obtained.

### EXAMPLES

Hereinafter, the details of the present disclosure will be described with reference to examples and comparative examples. The following Examples describe examples, and the present disclosure is not limited to the following Examples.

### Example 1

### [Production of Porous Silicon Particles]

Under an argon atmosphere, 0.65 g of silicon fine particles (particle diameter 5 μm, manufactured by Kojundo Chemical Laboratory Co., Ltd.) and 0.60 g of metal Li (manufactured by Honjo Metal Co., Ltd.) were mixed in an agate mortar to obtain a LiSi precursor. In a glass reactor under an argon atmosphere, 1.0 g of the LiSi precursor was allowed to react with 250 mL of 0° C. ethanol (manufactured by NACALAI TESQUE, INC.) for 120 minutes. Thereafter, a first liquid and a first solid reactant were separated from each other by suction filtration. In a glass reactor under an air atmosphere, 0.5 g of the obtained first solid reactant was allowed to react with 50 mL of acetic acid (manufactured by NACALAI TESQUE, INC.) for 60 minutes. Then, a second liquid and a second solid reactant were separated from each other by suction filtration. The second solid reactant was vacuum-dried at 100° C. for 2 hours to obtain porous silicon particles having a three-dimensional network structure. The porous silicon particles had a median size of 0.5 μm. The average pore diameter of the porous silicon particles calculated by the BJH method that is a gas adsorption measurement using nitrogen was 50 nm.

### [Production of Negative Electrode Active Material]

A carbon material was applied to the inner surface of each of the pores of the porous silicon particles by the following method using a CVD method. First, approximately 10 g of the porous silicon particles was put into a rotary kiln (a desktop rotary kiln manufactured by Takasago Industry Co., Ltd.) and nitrogen was supplied thereto while the kiln was being rotated at 1 rpm so that the inside of the kiln was made into a nitrogen atmosphere, and then the kiln was heated to a temperature of 600° C. In the state in which the temperature was maintained at 600° C., ethylene was introduced at 0.2 L/min and nitrogen was introduced at 1 L/min for 30 minutes. Thereafter, nitrogen was supplied thereto while the temperature was maintained at 600° C. for 2 hours, and the kiln was cooled slowly to room temperature to obtain a negative electrode active material. The ratio of the volume of the carbon material to the volume of the porous silicon particle was determined to be 1.1% using a carbon sulfur analyzer (CS844 manufactured by LECO corporation). SEM image observation of a cross-section of the negative electrode active material revealed that the carbon material was generated on the outer surface of each of the porous silicon particles and the inner surface of each of the pores.

### [Production of Sulfide Solid Electrolyte A]

Li₂S and P₂S₅ were weighed in an argon glove box having a dew point of −60° C. or lower. A molar ratio between Li₂S and P₂S₅ was 75:25. These were crushed and mixed in an agate mortar to obtain a mixture. Next, the mixture was subjected to milling under the conditions at 510 rpm for 10 hours using a planetary ball mill (Type P-7 manufactured by Fritsch GmbH) to obtain a glassy solid electrolyte. The glassy solid electrolyte was heat-treated under an inert atmosphere under the conditions at 270° C. for 2 hours. Li₂S—P₂S₅, which is a sulfide solid electrolyte A in the form of a glass ceramic, was thereby obtained.

### [Production of Positive Electrode Material B]

As a positive electrode active material, LiNi_{1/3}Co_{1/3}Mn_{1/3}O₂ (manufactured by NICHIA CORPORATION) was used. A surface of the positive electrode active material was subjected to a coating treatment using LiNbO₃. An amount of 1.5 g of the positive electrode active material, 0.023 g of a conductive additive (VGCF manufactured by Showa Denko K.K.), 0.239 g of the sulfide solid electrolyte A, 0.011 g of a binder (PVdF manufactured by KUREHA CORPORATION), 0.8 g of a solvent (butyl butyrate manufactured by KISHIDA CHEMICAL Co., Ltd.) each were weighed out and mixed using an ultrasonic homogenizer (UH-50 manufactured by SMT Co., Ltd.). Thereby, a positive electrode material B was obtained. “VGCF” is a registered trademark of Showa Denko K.K.

### [Production of Negative Electrode Material C]

In an argon glove box having a dew point of −60° C. or lower, 1.02 g of a negative electrode active material, 0.920 g of the sulfide solid electrolyte A, 0.03 g of a binder (PVdF manufactured by KUREHA CORPORATION), and 2.0 g of a solvent (butyl butyrate manufactured by KISHIDA CHEMICAL Co., Ltd.) each were weighed out and mixed using an ultrasonic homogenizer (UH-50 manufactured by SMT Co., Ltd.). No conductive additive, such as VGCF, was added. Thereby, a negative electrode material C was obtained.

### [Production of Secondary Battery]

The sulfide solid electrolyte A was weighed to 0.065 g and put in a 1 cm² ceramic mold. The content was pressed at 1 ton/cm² to produce an electrolyte layer.

The positive electrode material B was weighed to 0.030 g and put therein to be on one side of the electrolyte layer. The contents were pressed at 1 ton/cm² to produce a positive electrode active material layer. The negative electrode material C was weighed to 0.030 g and put therein to be on the other side of the electrolyte layer. The contents were pressed at 4 ton/cm² to produce a negative electrode active material layer. Thereby, a power generation element composed of the negative electrode active material layer, the electrolyte layer, and the positive electrode active material layer was obtained.

As a positive electrode current collector, an aluminum foil was disposed on the positive electrode active material layer side of the power generation element, and a current collector lead was fixed thereto. As a negative electrode current collector, a copper foil was disposed on the negative electrode active material layer side of the power generation element, and a current collector lead was fixed thereto. Thereby, a battery of Example 1 was obtained.

### Example 2

In the process of producing the negative electrode active material using a CVD method, ethylene was introduced at 0.2 L/min and nitrogen was introduced at 1 L/min for 1 hour in the state in which the temperature was maintained at 600° C. Except for this, a negative electrode active material and a battery of Example 2 were obtained in the same manner as in Example 1. The ratio of the volume of the carbon material to the volume of the porous silicon particle was 1.5%.

### Comparative Example 1

The porous silicon particles were used as the negative electrode active material without being combined with the carbon material. Except for this, a negative electrode active material and a battery of Comparative Example 1 were obtained in the same manner as in Example 1.

### Comparative Example 2

In the process of producing the negative electrode active material using a CVD method, ethylene was introduced at 0.4 L/min and nitrogen was introduced at 1 L/min for 30 minutes in the state in which the temperature was maintained at 600° C. Except for this, a negative electrode active material and a battery of Comparative Example 2 were obtained in the same manner as in Example 1. The ratio of the volume of the carbon material to the volume of the porous silicon particle was 3.0%.

### [Measurement of Specific Surface Area of Negative Electrode Active Material by Nitrogen Absorption Measurement]

The negative electrode active materials of Examples and Comparative Examples were measured for specific surface area by the gas adsorption method using a nitrogen gas. Specifically, adsorption isotherm data was obtained using a gas adsorption measurement apparatus using a nitrogen gas (BELLSORP MAX manufactured by MicrotracBEL Corp.). The obtained data was converted by a BET adsorption method to calculate the specific surface area. From the value of the calculated specific surface area, the ratio of the specific surface area of the negative electrode active material to the specific surface area of the porous silicon particle (corresponding to the negative electrode active material of Comparative Example 1) was calculated for each of Examples 1 and 2 and Comparative Example 2. Table 1 shows the results.

### [Charging Test]

Next, the batteries of Examples and Comparative Examples were subjected to a charging test under the following conditions.

First, each battery was disposed in a constant-temperature chamber at 25° C. Constant current charge and discharge were performed for the battery under a pressure of 5 MPa applied by a pressurizing jig. The charge final voltage was 4.05 V The discharge final voltage was 2.5 V. The constant current charge and discharge were initially performed at a C-rate of 0.3 C and then at a C-rate of 1 C (one hour rate) with respect to a theoretical capacity of the battery. On the basis of the obtained results, the discharge capacity ratio at a C-rate of 0.3 C as well as the discharge capacity ratio and the discharge capacity retention rate in the 100th cycle when 100 charge-discharge cycles were performed at a C-rate of 1 C were calculated. Table 1 shows the results. The discharge capacity ratio at a C-rate of 0.3 C and the discharge capacity ratio in the 100th cycle in Table 1 are values normalized with respect to the respective values of the battery of Comparative Example 1 as 100. Each discharge capacity retention rate in the 100th cycle in Table 1 is a value when the discharge capacity in the first cycle (before the cycle test) is taken as 100.

TABLE 1

| | | | | | | Discharge | |
|---|---|---|---|---|---|---|---|
| | | B | | | Discharge | capacity | |
| | A | Specific | | | capacity | retention | Discharge |
| | Specific | surface area | | | ratio | rate | capacity |
| | surface | of negative | | Volume | at 0.3 C | at 1 | ratio |
| | area | electrode | | ratio | before | C after | at 1 C |
| | of silicon | active | | of carbon | cycle | 100-cycle | after 100- |
| | particle | material | B/A | material | test | test | cycle test |
| | (m²/g) | (m²/g) | (%) | (%) | (%) | (%) | (%) |
| Comparative | 57 | (57) | (100) | — | 100 | 55 | 100 |
| Example | | | | | | | |
| 1 | | | | | | | |
| Example | 47 | 34 | 72 | 1.1 | 104 | 70 | 132 |
| 1 | | | | | | | |
| Example | 57 | 30 | 53 | 1.5 | 111 | 82 | 165 |
| 2 | | | | | | | |
| Comparative | 58 | 20 | 34 | 3.0 | 89 | 40 | 64 |
| Example | | | | | | | |
| 2 | | | | | | | |

### «Consideration»

In the batteries of Examples 1 and 2, the discharge capacity ratio in the first cycle (before the cycle test), and the discharge capacity ratio and the discharge capacity retention rate in the 100th cycle were all higher than in the batteries of Comparative Example 1 and 2. This is conceivably because in Examples 1 and 2, a lot of electron conduction paths were formed between the porous silicon particles and the carbon material in the negative electrode active material. This is also conceivably because in Examples 1 and 2, the carbon material was maintained in the vicinity of the porous silicon even when the expansion and shrinkage of the porous silicon particles due to charge-discharge cycle occurred.

As for the battery of Comparative Example 2, the discharge capacity retention rate decreased in particular. This is conceivably because in the battery of Comparative Example 2, the ratio of the specific surface area of the negative electrode active material to the specific surface area of one of the porous silicon particles was as low as 34%, and as a result, the space for expansion at the time of charging and discharging failed to be ensured sufficiently in the negative electrode active material.

### INDUSTRIAL APPLICABILITY

The battery of the present disclosure can be used, for example, as an all-solid-state lithium secondary battery.

What is claimed is:

1. A negative electrode active material comprising:
a porous silicon particle; and
a carbon material, wherein
the porous silicon particle has a plurality of pores,
the carbon material covers at least a part of an inner surface of each of the pores, and
a ratio of a specific surface area of the negative electrode active material to a specific surface area of the porous silicon particle is 40% or more and 99% or less.

2. The negative electrode active material according to claim 1, wherein
the ratio of the specific surface area of the negative electrode active material to the specific surface area of the porous silicon particle is 50% or more and 75% or less.

3. The negative electrode active material according to claim 1, wherein
a ratio of a volume of the carbon material to a volume of the porous silicon particle is 0.01% or more and less than 2%.

4. A battery comprising:
a negative electrode;
a positive electrode; and
an electrolyte layer disposed between the negative electrode and the positive electrode, wherein
the negative electrode includes the negative electrode active material according to claim 1.
